(19) United States
(12) Patent Application Publication
(10) Pub. No.: US 2012/0140235 A1
(43) Pub. Date: Jun. 7, 2012

(54) METHOD FOR MEASURING THE FILM ELEMENT USING OPTICAL MULTI-WAVELENGTH INTERFEROMETRY

(76) Inventors: Cheng-Chung LEE, (US); Kai Wu, (US)

(21) Appl. No.: 13/152,902

(22) Filed: Jun. 3, 2011

(30) Foreign Application Priority Data
Dec. 6, 2010 (TW) 099142378

(51) Int. Cl. G01B 9/02

(52) U.S. Cl. 356/450

(57) ABSTRACT

A method for measuring the film element using optical multi-wavelength interferometry is revealed. The invention uses reflection coefficients of thin films at different wavelengths to measure the thickness and optical constants of thin films. The phase difference coming from the phase difference between test and reference surfaces is distinguished from the phase difference from the spatial path difference between reference and test beams by doing measurements on different wavelengths, because they change in different ways as the measuring wavelength changes. The phase is then acquired. Combining with the measured reflectance of thin film, the reflection coefficient of thin film is obtained. Collecting the reflection coefficients of each point, the thin film thickness and optical constants distribution in 2 dimensions are calculated. The surface profile is known through the spatial path differences between reference and test beams. These can be measured in a interferometer to avoid the vibration influence.

### BACKGROUND OF THE INVENTION

1. Field of Invention

The present invention relates to a method for measuring film and, in particular, to a method for measuring the film element using optical multi-wavelength interferometry.

2. Related Art

Non-contact photometry transmission and reflection intensity spectrum are generally used to learn the optical constants and thickness of thin films today. But the measurements accuracy and precision are lower than ellipsometer measurements, especially in multilayer film stack measurement, since ellipsometry measurements measure both coatings' reflection magnitude and phase at the same time to increase the precision of the answers. However, the ellipsometer can not measure the 2-dimeional thickness and optical constants of thin film; the surface profile of the substrate and the residual stress cannot be known by the ellipsomter.

Recent researches used measured reflection magnitude spectra to calculate the thickness and refractive index in an optical interferometer and measured phase spectra to obtain the surface profile. However, unlike the ellipsometer, these methods didn't use both spectral phase and magnitude at the same time to enhance the precisions and some of them didn't have anti-vibration ability.

This invention use both reflection magnitude and phase from the tested thin films to solve the optical constants and thickness to enhance the solutions precisions. The measuring system can be a non-contact and anti-vibration system. It provides global capabilities for measuring thin film elements, including surface profile.

### SUMMARY OF THE INVENTION

The purpose of this invention is to provide a novel measuring method. By the physical property measurement of the thin film, measurement information is acquired using optical interferometry.

A method for optical measuring the film element using multi-wavelength interferometry is revealed. This invention use reflection coefficients of thin films at different wavelengths to measure the thickness and optical constants of thin films. The tested thin film sample was measured in an optical interferometer. The white light is separated in different wavelength in measurements by narrow band-pass filter or dispersive elements. The phase difference coming from the reflection phase difference between test and reference surfaces is distinguished from the phase difference coming from the spatial path difference between reference and test beams by doing measurements on different wavelengths, because they change in different ways as the measuring wavelength changes. The reflection phase of thin film stack is then acquired. Combining with the measured reflectance of the thin film element, the reflection coefficient of the thin film is obtained. Collecting the reflection coefficients under normal incidence of light of each point, the thin film thickness and optical constants distribution in 2 dimensions are calculated. The surface profile is also known through the spatial path differences between reference and test beams. These can be measured in a dynamic interferometer composed of a polarization interferometer and a pixelated phase-mask camera to avoid the vibration influence.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing the measuring device according to one preferred embodiment of the invention;

FIG. 2 is a diagram showing the Polarizer distribution on pixelated phase mask camera according to one preferred embodiment of the invention;

FIG. 3 is a flow chart according to one preferred embodiment of the invention; and

FIG. 4 is a diagram showing a measurement of multi-wavelength according to one preferred embodiment of the invention.

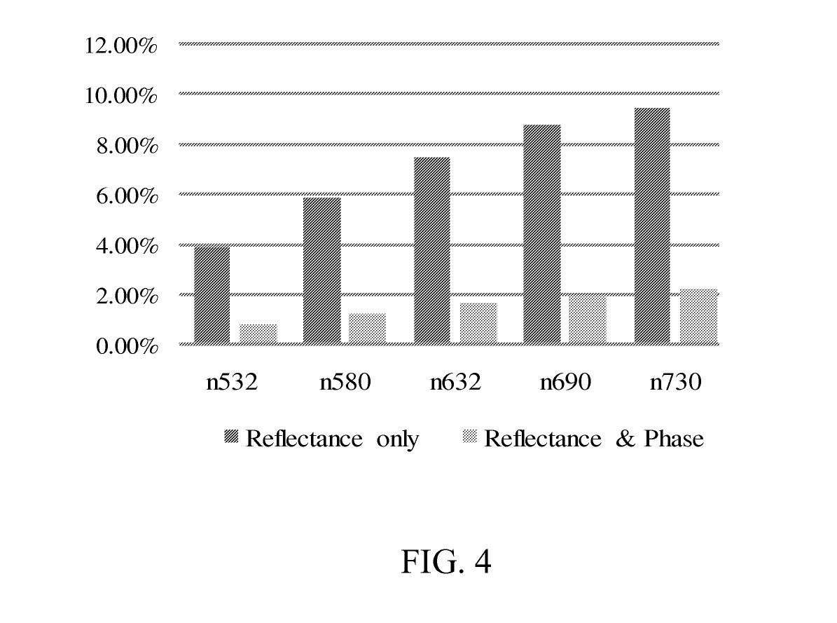

### DETAILED DESCRIPTION OF THE INVENTION

The present invention will be apparent from the following detailed description, which proceeds with reference to the accompanying drawings, wherein the same references relate to the same elements.

In this invention, both magnitude and phase of reflection coefficient of thin films are acquired in a dynamic white light interferometer, which is composed of an optical polarization interferometer and a pixelated phase mask camera to obtain the optical constants and thickness of the thin films with vibration and air turbulence resistance.

The phase measured in an interferometer is the phase difference between the reference and test beams. It is composed of two parts: spatial path length difference and reflection phase difference between the reference surface and thin film surface. Multi-wavelength measurements of phase and intensity are used to separate these two parts, because they all change in different ways when measuring wavelength changes.

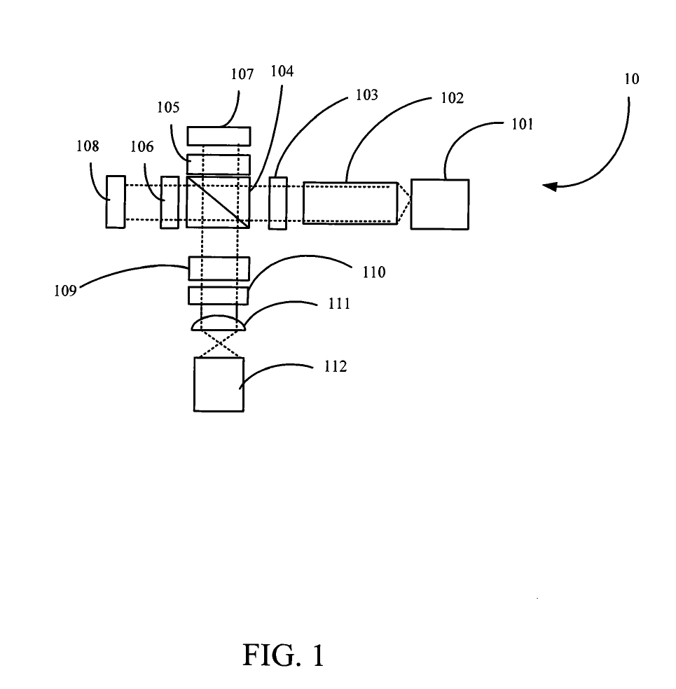

Referring to FIG. 1, a multi-wavelength optical device 10 includes a light source 101, a collimator 102, a polarizer 103, a polarization beam splitter 104, two quarter-wave plates 105, 106, a reference surface 107, a test surface 108, a quarter-wave plate 109, a narrow band-pass filter 110, a imaging lens 111 and a detecting element 112. The test surface 108 is a thin film surface. The detect element 112 is a pixelated phase-mask camera, which is a birefringence crystal array aligned pixel array combining with a polarizer, or a polarizer array aligned pixel matrix combining with a quarter-wave plate, for capturing phase.

The light source 101 is placed on one side of the collimator 102. The polarizer 103 is placed on the other side of the collimator 102. The polarizer 103 is also placed on a first side of the polarization beam splitter 104. One side of the quarter-wave plate 105 is placed on a second side of the polarization beam splitter 104, and one side of the quarter-wave plate 106 is placed on a third side of the polarization beam splitter 104. The reference surface 107 is placed on the other side of the quarter-wave plate 105, and the test surface 108 is placed on the other side of the quarter-wave plate 106. One side of the quarter-wave plate 109 is placed on a fourth side of the polarization beam splitter 104. One side of the narrow band-pass filter 110 is placed the other side of the quarter-wave plate 109. The imaging lens 111 is placed between the narrow band-pass filter 110 and the detecting element 112.

As shown in FIG. 1, after the light is emitted from the white light source 101, it is then collimated by the collimator 102. The collimated light will pass through the polarizer 103, which can be used to adjust the intensity ratio between the two orthogonally polarized beams. The polarization beam splitter (PBS) 104 will separate the two orthogonally polarized beams to different arms in the Twyman-Green interferometer. The two quarter-wave plates 105, 106 placed around the polarization beam splitter 104 were oriented to convert S to P polarized beam reflected from the reference surface 107 and P to S polarized reflected from the test surface, which is the surface of the thin films 108, respectively. After passing through the quarter wave plate 109 in front of the narrow band-pass filter 110, they then were converted to right and left circular polarizations, respectively.

These two beams then had interference with each other after they pass through a linear polarizer. If the polarizer was oriented at an angle α with respect to the x axis, the intensity would be:

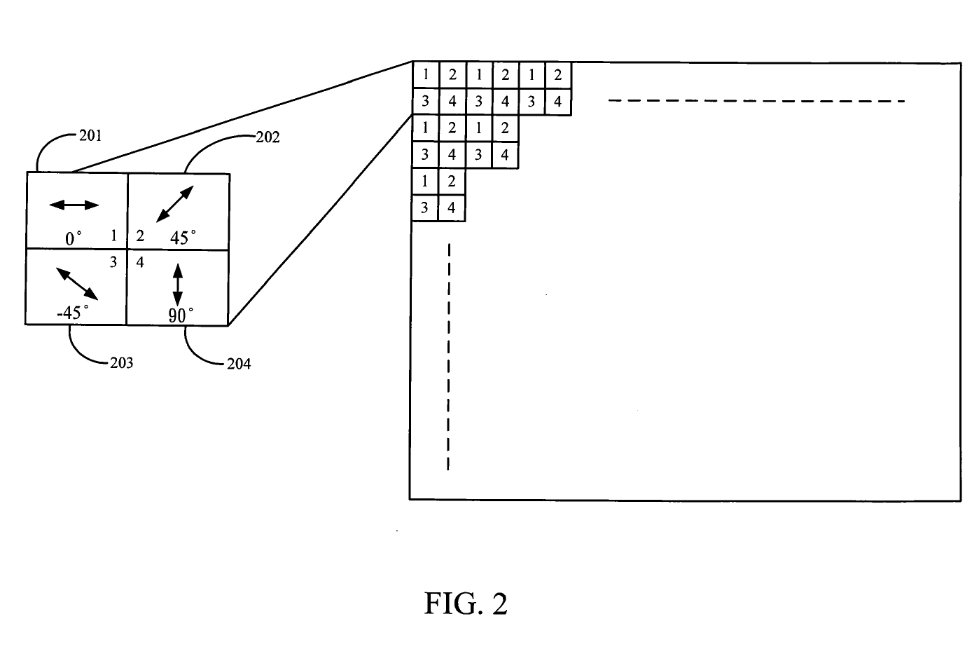

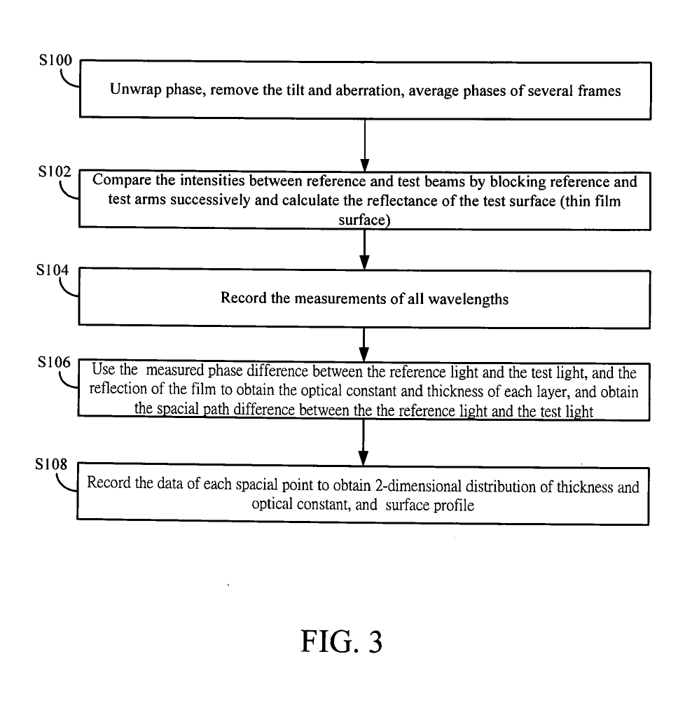

I=I_{T}+I_{R}−2\sqrt{I_{T}I_{R}} cos(2α+δₘ) (1)

where I_{T} and I_{R} were the intensities coming from the test and reference surfaces, respectively. δₘ was the measured phase difference between the two beams. After passing through the imaging lens 111, the light beams go to the detecting element 112. The detecting element in the system is a pixelated micro-polarizer camera, and the adjacent pixels, have different orientation polarizer on them as shown in FIG. 2. There might be four different polarizers in a unit, 201, 202, 203, 204, and the unit is distributed periodically in the CCD array. FIG. 3 indicates the corresponding phase shifts are induced on CCD array of the camera. There were four different polarizers at 0°, 45°, −45°, 90°, respectively, on the camera, and they generate four different phase shifted interferograms at once for phase shifting algorithm. Hence, δₘ can be derived without moving reference arm by piezoelectric transducer to avoid the vibration influence. The phases should be unwrapped first, and the tilt should be removed. The obtained data in several frames should be averaged to erase the air turbulence influence.

The narrow band-pass filter is utilized to separate or select the measuring wavelength. It can be also be replaced by a dispersive element, like a diffraction grating, to do multi-wavelength measurements at once. Consider a light beam normally incident into a film stack of m layers. To satisfy the electromagnetic boundary conditions at the interfaces in a single layer thin film as shown in FIG. 2(a), the following equations are satisfied:

$$[ \begin{matrix}B \\ C\end{matrix} ] = {\prod }_{j = 1}^{m} [ \begin{matrix}cos {δ}_{j} & \frac{i}{{n}_{j} {y}_{v}} sin {δ}_{j} \\ {in}_{j} {y}_{v} sin {δ}_{j} & cos {δ}_{j}\end{matrix} ] [ \begin{matrix}1 \\ {n}_{s} {y}_{v}\end{matrix} ] \qquad ( 2 )$$

where yᵥ is the optical admittance in vacuum. The layer next to the incident medium is the 1^{st} Layer, the layer close by the substrate is the m^{th} Layer, and so on. δⱼ is the optical phase thickness of the j^{th} Layer thin film, which equals to 2πndⱼ/λⱼ, where dⱼ and nⱼ are the thin film physical thickness and refractive index of the j^{th} Layer, respectively. nₛ is the refractive index of substrate.

$${re}^{{iδ}_{T}} = \frac{{n}_{0} {y}_{v} B - C}{{n}_{0} {y}_{v} B + C} \qquad ( 3 )$$

Bring B and C in Eq. (2) to Eq. (3). All yᵥ terms will be canceled in the final calculations. Thus, the reflection coefficient of multilayer film stack can be derived as a function of nⱼ, dⱼ and λ. Because the light is at normal incidence, the reflection coefficient mathematic expression is much simpler than that in oblique incidence, like in ellipsometer. For a thin film has absorption, nⱼ in Eq. (2) should be replaced by nⱼ−ikⱼ, where kⱼ is the extinction coefficient of the j^{th} Layer thin film.

r equals to the square root of thin film reflectance R. The reflectance R can be measured by comparing the detected intensity between the test sample and a reference specimen when the reference arm is blocked. Then, by minimizing the following error function, the nⱼ(λ), dⱼ, and h can be found.

$$E ( {δ}_{T} , {δ}_{S} , r ) = {\sum }_{i = 1}^{w} \{ {\vert {δ}_{m} ( {λ}_{i} ) - [ {δ}_{T} ( {n}_{1 ( {λ}_{1} )} … {n}_{m ( {λ}_{i} )} , {d}_{1} … {d}_{m} , {λ}_{i} ) - {δ}_{R} ( {λ}_{i} ) + {δ}_{S} ( h , {λ}_{i} ) ] \vert}^{2} + {\vert η [ {r}_{m} ( {λ}_{i} ) - r ( {n}_{1 ( {λ}_{i} )} … {n}_{m ( {λ}_{i} )} , {d}_{1} … {d}_{m} , {λ}_{i} ) ] \vert}^{2} \} \qquad ( 4 )$$

where δₘ and rₘ are the measured reflection magnitude and measured total phase, respectively. δT and r can be derived from models described in Eq. (2) and Eq. (3). Since reflection phase and magnitude are in different units and dimensions, η is a weighting factor, which should be adjusted to let them have about the same value dimension. Its' value is not limited and critical. As the wavelength changed, the spatial path difference δS will be simply changed by a wavelength factor, that is, δ_{S}′=(λ/λ′) δ_{S}, where λ and λ′ are the original and current measuring wavelengths, respectively. Because δ_{S} and δ_{T} change in different ways when measuring wavelength changes, thus they can be distinguished from each other.

Referring to FIG. 3, a flow chart of the method for measuring the film element using optical multi-wavelength interferometry is presented. As the step 100, a dynamic interferometer 10 is used to measure thin film with a reference beam and a test beam. The test beam is reflected from the test surface 108 to form the first reflected beam. The reference beam is reflected from the reference surface 107 to form the second reflected beam. The first reflected beam and the second reflected beam interfere with each other, respectively. Then, use a light sensing element 112 receiving the reflected reference beams and the reflected test beams, unwrap phase of the reflected beams, remove the tilt and aberration of the reflected beams, average phases of several frames for erasing the air turbulence influence.

As the Step S102, by blocking reference beam, compare the light intensities reflected from the tested sample and reflected from a reference sample of which the reflectance is unknown before test to calculate the reflectance of the test surface (thin film surface) for acquiring the reflectance of the test surface in accordance with light intensity of the reflected beams. As the step S104, record the measurements of all wavelengths. As the step S106, use the measured phase difference between the reference light and the test light and the reflectance of the film to obtain the optical constant and thickness of each layer, and obtain the spatial path difference between the reference light and the test light. Finally, as the step S108, collect the data of each unit to acquire the 2-dimensional distribution of thickness and optical constant, and the surface profile of the thin film.

TABLE 1
Experimental results comparisons

| | | | Reflectance Only | Reflectance + Phase |
|---|---|---|---|---|
| | | Ellipsometer | (AVG/SD) | (AVG/SD) |
| 1st Layer | D | 93 nm | 80 nm/6.89% | 90 nm/1.45% |
| | n₍₆₃₀₎ | 1.48 | 1.65/4.13% | 1.48/0.79% |
| 2nd Layer | d | 98 nm | 95 nm/3.52% | 98 nm/0.89% |
| | n₍₆₃₀₎ | 2.14 | 1.89/3.91% | 2.15/1.20% |

Experimental results were compared with the ellipsometer measurements, as shown in Table 1. Sopra GESS ellipsometer was employed to do measurements every 5 nm from 450 nm to 800 nm (total number of ellipsometer measuring wavelengths was 70) for comparisons. Genetic algorithm was employed to find the answers to Eq. (3). Cauchy's Equation was applied for fitting the dispersion of the refraction indices. The light source in the interferometer was a 200 watt mercury lamp, and whole system was set on a table without any anti-vibration mechanism. The test sample was a transparent BK7 glass with 1 mm thickness and 2 wavelengths flatness and coated with two thin film layers of SiO₂ (1st layer) and Ta₂O₅ (2nd layer) on it. The films were prepared by ion beam sputtering deposition. Narrow band-pass filters with 10 nm spectrum bandwidth were used to select measuring wavelengths. Only 8 wavelengths, 532 nm, 550 nm, 580 nm, 589 nm, 630 nm, 656 nm, 690 nm and 710 nm, were used for measurements.

The averages (AVG) and standard deviations (SD) of thickness “d” and refraction index at 630 nm “n(630)” measurement results are listed in the table for comparisons. The statics come from 50 calculations under the same calculation condition. One can see that the results of only using reflectance measurements have large calculation standard deviation (low precision) and low accuracy. This is because that the measurement data are obviously too less and insufficient for numerical fitting. However, after the optical phase measurement data were added into calculations, the precision were obviously improved and the results are similar to ellipsometer results. The optical phases measured from the interferometer indeed help us to obtain more precise results. Notice that the precision will be further improved when more wavelengths were used for measurements.

Since this system can do measurements under normal incidence and the detecting element is a 2D CCD array, the whole profile of the element can be measured at the same time.

By placing proper lens set in front of the test arm, the measurement area can be enlarged. It could provide high precision examinations for production of any curved or patterned substrate coated with thin films.

Not only the reflection magnitude but also the reflection phase was used to measure the refractive index and thickness of thin film for obtaining higher precision in this vibration insensitive system. The system, combining two capabilities, surface profiling and thin film inspection, and enable be further developed as in-line inspection system for various applications, such as thin-film photovoltaics, semiconductor, flat panel displays, biomedical specimen, etc. . . . Table 1

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for measuring the film element by using optical multi-wavelength interferometry, comprising:
using an interferometer for measuring a thin film with a reference beam and test beam of different wavelengths, the test beam reflected from a test surface to form the first reflected beam, the reference beam reflected from the test surface to form the second reflected beam;
the first reflected beam and the second reflected beam interfere with each other respectively, the thin film deposited on the test surface;
using a light sensing element receiving the reflected reference beam and the reflected test beam, and acquiring the reflectances of the test surface in accordance with light intensity of the reflected beam;
the light sensing element receiving the interfering beams and obtaining a plurality of phases in accordance with the interfering beams; and
acquiring each layer thickness and optical constants of the thin film according to the phases and the reflectances of the thin film.

2. The method as claimed in claim 1, wherein the test surface is a thin film stack surface.

3. The method as claimed in claim 1, wherein the step of using an interferometer measuring a thin film with the reference beam and test beam of different wavelengths, the interferometer acquires the first reflected beam and the second reflected beam of different wavelengths through a light filtering element or a dispersion element to separate the light wavelengths.

4. The method as claimed in claim 1, wherein the interferometer includes the light sensing element to measure interference intensity on each pixel.

5. The method as claimed in claim 1, wherein the light sensing element is a pixelated phase-mask camera, of which each pixel sensing unit can generate a phase shift to the phase difference between test and reference light, and the phase shift is different from that of the around adjacent pixels.

6. The method as claimed in claim 5, wherein the pixelated phase-mask camera is a birefringence crystal array aligned pixel array combining with a polarizer.

7. The method as claimed in claim 5, wherein the pixelated phase-mask camera is a polarizer array aligned pixel array combining with a quarter-wave plate.

8. The method as claimed in claim 5, wherein the sensing result of the pixelated phase-mask camera includes pixels, the pixels are set by a unit per four pixels, each unit is recorded a phase.

9. The method as claimed in claim 1, wherein the step of the light sensing element receiving the interfering beams and obtaining a plurality of phases in accordance with the interfering beams is the light sensing element receives all reflected light and generates different phase shift inteferograms, then the interferometer obtains the phases according to the phase shifted interferograms.

10. The method as claimed in claim 1, wherein the step of the light sensing element receiving the interfering beams and obtaining a plurality of phase differences in accordance with the interfering beams is using a phase-shifting algorithm to acquire the phase differences between the reflected beams from the reference surface and the test surface.

11. The method as claimed in claim 1, wherein the step of acquiring the reflectances of the test surface in accordance with light intensity of the reflected beams is acquiring the reflectances by comparing the light intensity reflected from the tested thin film stack and from a reference surface of which reflectance is known before test.

12. The method as claimed in claim 1, wherein the step of using an interferometer measuring a thin film with the reference beam and test beam of different wavelengths is using the reflectances of the thin film in multi-wavelength and the data of the phase difference between the reference beam and the test beam in different wavelengths to acquire the reflection coefficient of the thin film and the spatial path difference between the test light and the reference light.

13. The method as claimed in claim 1, wherein the step of acquiring each layer thickness and optical constants of the thin film according to the phases and the reflectances of the thin film is using the reflection coefficients to acquire the optical constant and the thickness of the thin film.

14. The method as claimed in claim 13, further comprising a step of collecting each spatial point data to acquire the 2-dimensional distribution of thickness and optical constant.

15. The method as claimed in claim 1, further comprising a step of detecting the surface profile of the thin film and substrate according to path difference between the reference light and the test light of each spatial point.
